(19) United States
(12) Patent Application Publication
(10) Pub. No.: US 2023/0132230 A1
(43) Pub. Date: Apr. 27, 2023

(54) Efficient Video Execution Method and System

(71) Applicant: Spectrum Optix Inc., Vancouver (CA)

(72) Inventors: Kevin Taylor Gordon, Calgary (CA); Colin Thomas D'Amore, Edmonton (CA); Timothy James Put, Edmonton (CA)

(21) Appl. No.: 17/970,279

(22) Filed: Oct. 20, 2022

Related U.S. Application Data
(60) Provisional application No. 63/270,325, filed on Oct. 21, 2021.

(51) Int. Cl. G06N 3/04; G06T 7/20

(52) U.S. Cl. CPC G06N 3/0454; G06T 7/20; G06T 2207/20084

(57) ABSTRACT

An image processing pipeline includes an image processing system having multiple neural networks arranged to receive multiple input images, with the images having identifiable objects and noise features. A first neural network provides image information to a second neural network that recurrently processes the image information to both improve output presentation of identifiable objects and reduce noise features. In some embodiments other local or remote neural networks can be arranged to modify at least one of an image capture setting, sensor processing, global post processing, local post processing, portfolio post processing, or provide latent vectors or neural embedding information.

### RELATED APPLICATION

This application claims the benefit of U.S. Provisional Application Ser. No. 63/270,325, filed Oct. 21, 2021, and entitled EFFICIENT VIDEO EXECUTION METHOD AND SYSTEM, which is hereby incorporated by reference in its entirety.

### TECHNICAL FIELD

The present disclosure relates to systems for improving images using neural network processing techniques that utilize information from multiple related images. Described is a method and system using neural networks that reduces image processing requirements by providing for a reduction in redundant processing of selected images or video frames.

### BACKGROUND

Digital image or video cameras typically require a digital image processing pipeline that converts signals received by an image sensor into a usable image by use of image processing algorithms and filters. For example, motion compensating temporal filters have been employed to reduce sensor noise in video streams. Typically, motion compensating temporal filters match image subregions across the time domain and use the matched region sequences to generate a better estimate of the underlying signal. This algorithm takes advantage of the fact that many sources of image noise are normally distributed, and averaging multiple samples leads to less variation (as expected due to the central limit theorem).

As another example, modern video codecs can use patch based matching and affine warping. A key frame is encoded and transmitted along with the per-path warping parameters. During decoding this datum are used to reconstruct the original images. Advantageously, by transmitting these keyframes and warp parameters the resulting encoded video stream is significantly less bandwidth intensive, at the cost of additional computation during the encoding and decoding steps. However, many of these algorithms are proprietary, difficult to modify, or require substantial amounts of skilled user work for best results. Methods and systems that can improve image processing, reduce user work, and allow updating and improvement are needed.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates a recurrent architecture neural network that utilizes multiple neural networks that process selected grids mapped onto an image and includes input from previously processed images;

FIG. 1B illustrates a recurrent architecture neural network that utilizes multiple neural networks that process selected grids mapped onto an image and includes input from previously computed state vectors;

FIG. 1C illustrates a recurrent architecture neural network that utilizes multiple neural networks that process selected grids mapped onto an image and includes both input from previously processed images and input from previously computed state vectors;

FIG. 1D illustrates a neural network supported image or video processing pipeline that provides efficient video processing using multiple neural networks;

FIG. 1E illustrates a neural network supported image or video processing system that efficient video processing using multiple neural networks;

FIG. 1F is another embodiment illustrating a neural network supported software system that provides efficient video processing using multiple neural networks;

FIG. 2 illustrates a system with control, imaging, and display sub-systems, with alternative processing schema for the imaging system being indicated; and

FIG. 3 illustrates one example of neural network processing of RGB or Fourier images that provides efficient video processing using multiple neural networks;

### DETAILED DESCRIPTION

In some of the following described embodiments, methods, processing schemes, and systems for improving neural network processing are described. Neural network processing embodiments that provide efficient video processing using multiple neural networks are described. Video streams can be modelled as a sequence of still images. Processing a video stream can be carried out by independently processing each image in the video stream. However, independent processing can result in redundant processing of identical images or subregions of images and discards temporal information that could otherwise be used to improve image quality or image processing speed.

For example, in one embodiment noise can be reduced using efficient video processing that eliminates redundant or low value image processing using multiple neural networks and data from previous images or video frames. Alternatively, or in addition, object tracking and motion compensation can be improved. In effect, such methods, processing schemes, or system embodiments can, for example, provide improved object tracking and motion compensation, or reduce visual artifacts due to noise or other video frame features that persist across multiple frames.

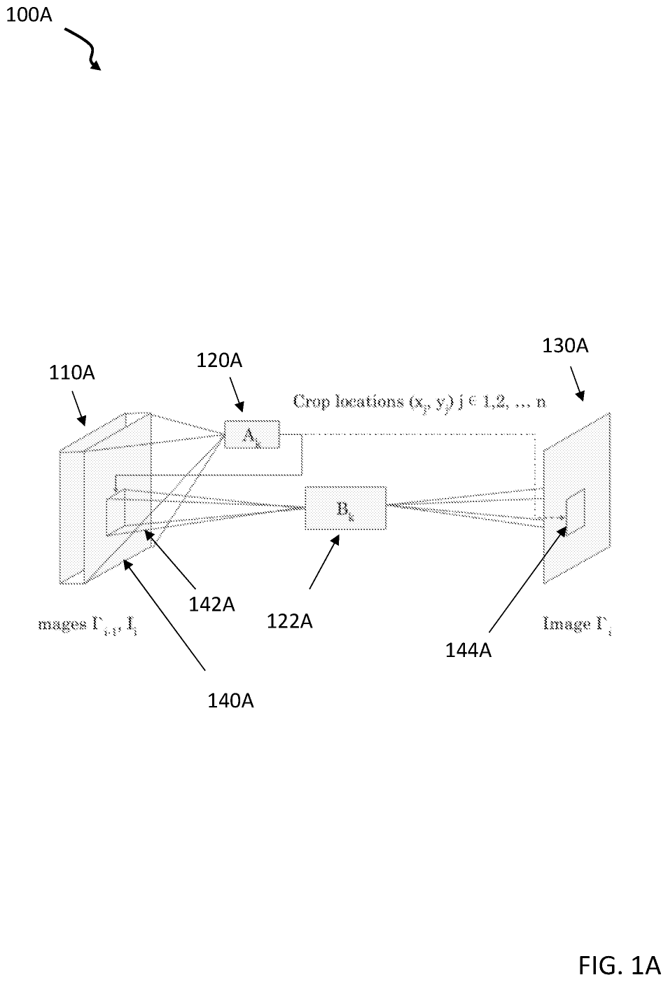

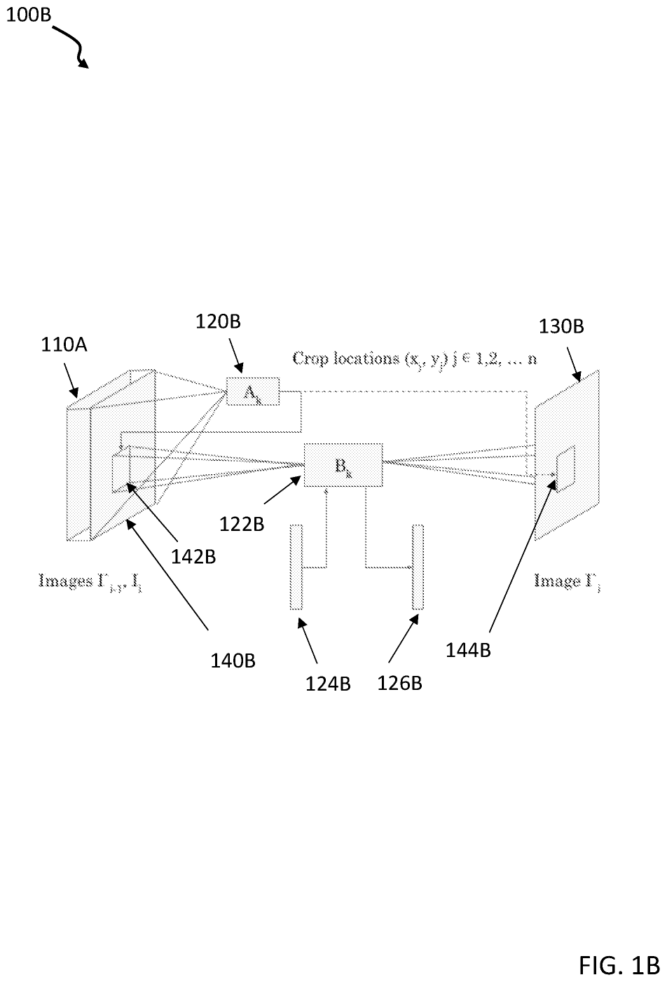

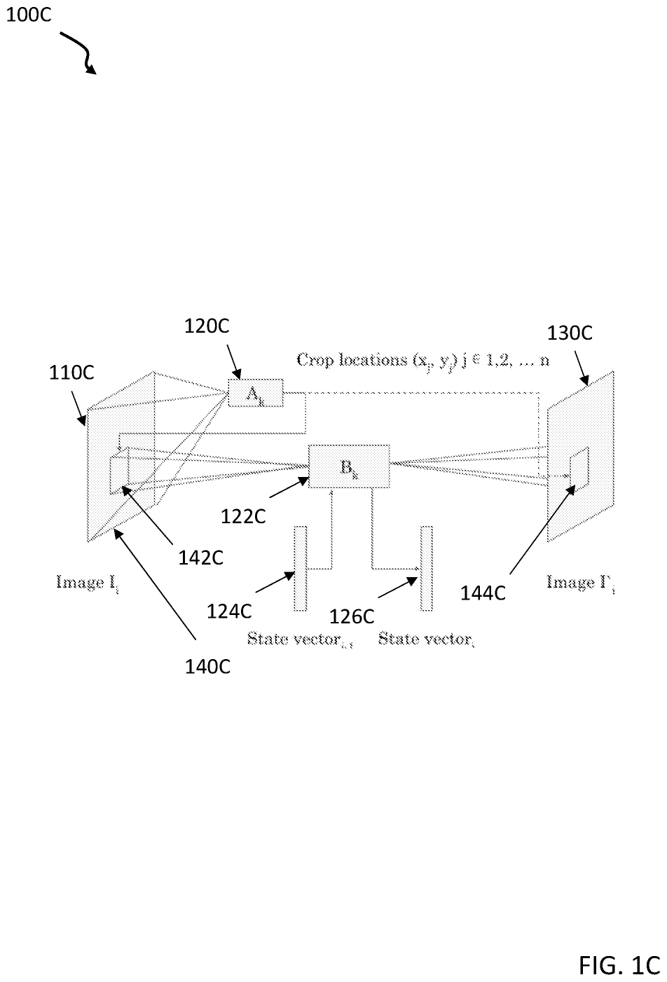

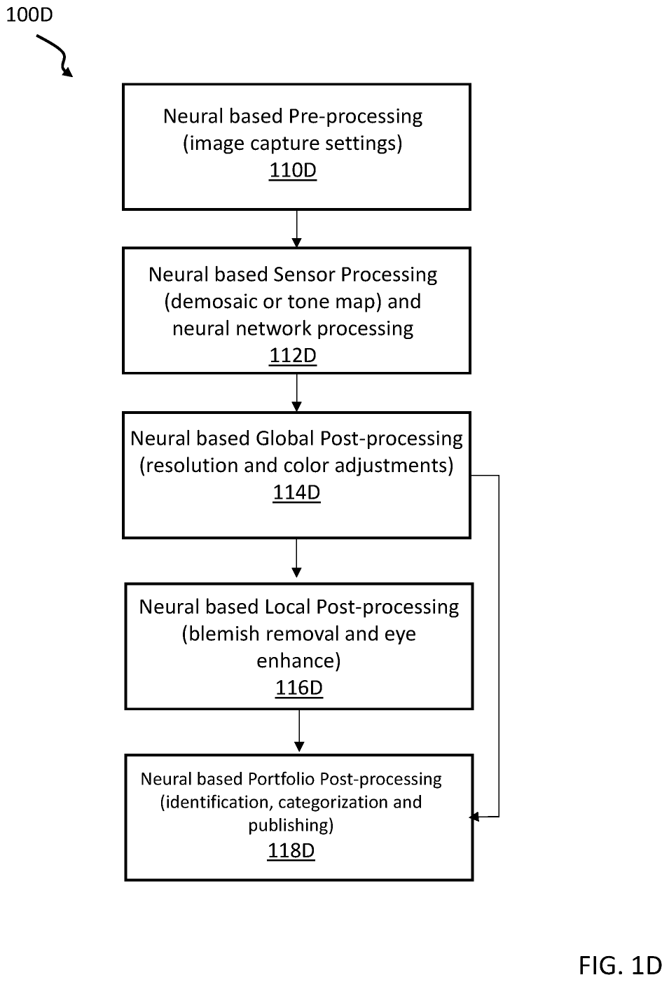

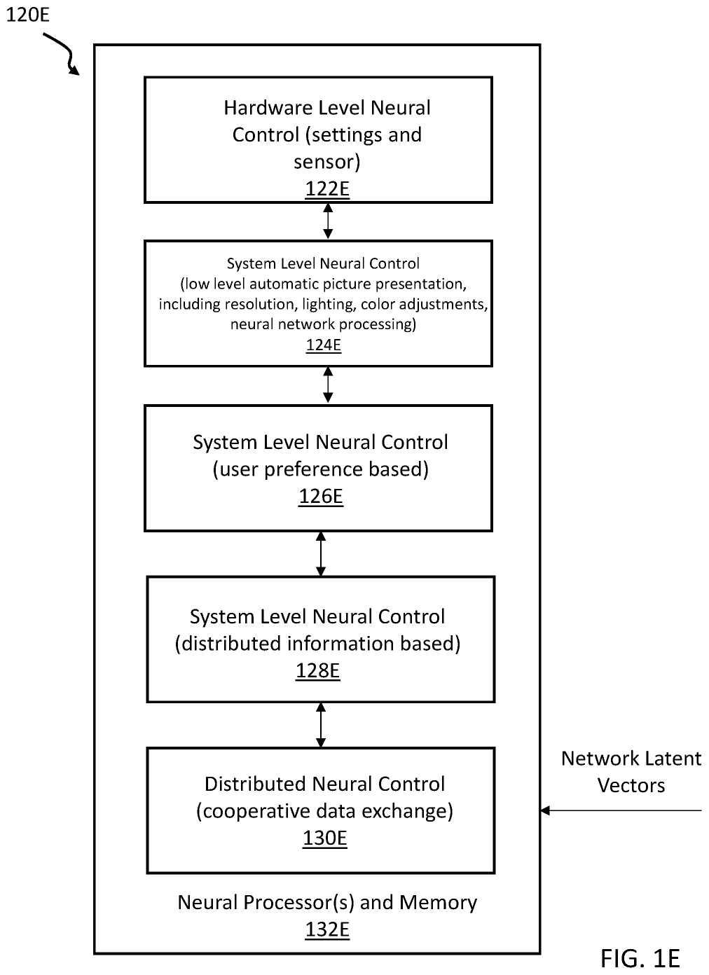

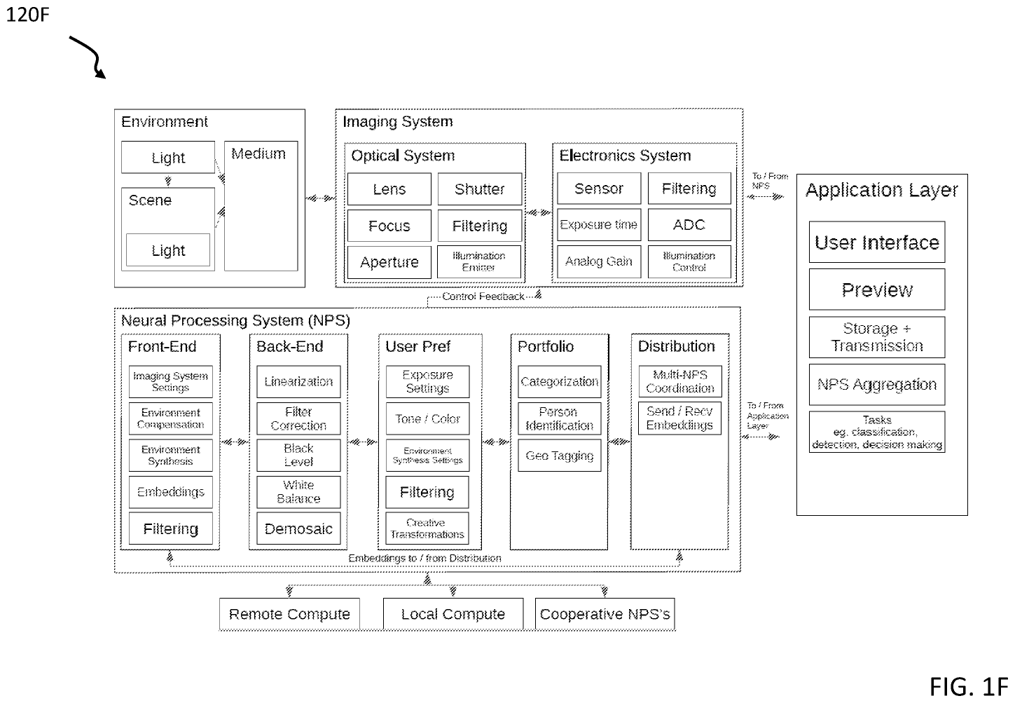

FIG. 1A illustrates a neural network method or system that utilizes multiple frame processing to provide efficient video processing using multiple neural networks. As illustrated, a system or method 100A has one or more video frames as input 110A into a first neural network 120A. A substantial or entire portion of image frame 140A is processed provide a cropping layer that is used to identify features that can require additional neural network processing. A second neural network 122A can be used to process portion 142A if a need for suitable processing is identified by neural network 120A. In some embodiments, the combination of the first neural network 120A and second neural network 122A can together define a third neural network that is usable for image processing. This third network can be trained to minimize error between the input 110A and the output 130A. Output 130A can include a processed portion 144A, along with other processed or unprocessed image portions that together define an output image. The input frames can include multiple frames preceding the most recent frame from the video stream.

Various techniques can be used to determine which portions of an image can or need to be processed to best utilize processing power available to multiple neural networks. In one embodiment, the input image can be subdivided into a uniform grid of arbitrary size, yielding m grid elements. Randomly select n<=m grid elements, process with the neural network, and copy to the output image buffer. In other embodiment that uses greedy minimum cost evaluation, grid elements are assigned a cost per some scheme (e.g. cost=abs(input image−output buffer)). The grid elements can be sorted by cost and n<=m grid elements selected. These n elements are processed using a neural network and copied to the output 130A.

In another example, instead of RGB or other images, a Fourier or other frequency domain transform can be processed using a greedy minimum cost in the frequency domain. This technique can include elements used by conventional greedy minimum cost algorithms but can further include ensuring that the input image and output image buffer have corresponding Laplacian pyramids. Cost can be computed on the Laplacian pyramids, which can include linear invertible image representation images of a set of band-pass images, commonly spaced an octave apart, plus a low-frequency residual. Alternatively or in addition, linear transforms useful in the disclosed image processing method can include, for example, discrete Fourier and discrete Cosine Transforms, Singular Value Decomposition, or Wavelet Transforms.

Neural network cost minimization for any of the described techniques can be end-to-end in the framework of neural network optimization. A small first network 120A is used to regress on the (xi,yi) coordinate of a patch to be considered for processing. Network 120A can be configured to regress n such coordinates. These output coordinates can be fed to a cropping layer, that can either be standalone or a first layer of neural network 122A.

As will be understood, Networks 120A, 122A, or any addition neural networks can process in either spatial or frequency domain. Additional metadata layers such as segmentation maps, saliency maps, or object localization information can be input into the networks to guide the optimization process to a users' preference. Similarly, network 120A might output a per-subregion (superpixel, tile grid element, class) confidence estimate of the current output buffer, to be fed recurrently into neural network 120A at the next time step. Many versions of neural network 120A might exist, with different crop extends (sizes), such that an operator can use to balance large grids or patches vs small grids or patches. Similarly, this decision making process (how many and what size patches) can also be framed as an optimization problem and cost minimized in an end-to-end fashion.

FIG. 1B illustrates a recurrent architecture neural network that utilizes multiple neural networks that process selected grids mapped onto an image and further includes input from previously computed state vectors. As illustrated, a system or method 100B has one or more video frames as input 110B into a first neural network 120B. A substantial or entire portion of image frame 140B is processed provide a cropping layer that is used to identify features that can require additional neural network processing. A second neural network 122B can be used to process portion 142B if a need for suitable processing is identified by neural network 120B. Information derived from previous frames is provided to second neural network 122B from neural embeddings, latent vectors, or state vectors 124B and 126B. Such neural embeddings, latent vectors, or state vectors 124B and 126B inputs can provide information in a lightweight and processor ready format that helps the neural network 122B utilize information from the previous frame and predict the succeeding frame. Using neural embedding, latent vectors, or state vectors, dimensionality of a processing problem can be reduced and image processing speed greatly improved. In effect, neural embedding, latent vectors, or state vectors provide a mapping of a high dimensional image to a position on a low-dimensional manifold represented by a vector (“latent vector”). Components of the latent vector are learned continuous representations that may be constrained to represent specific discrete variables. In some embodiments a neural embedding can be a mapping of a discrete variable to a vector of continuous numbers, providing low dimensional, learned continuous vector representations of discrete variables. Information from processed images 110B can be combined with neural embedding, latent vectors, or state vectors for processing by system 100B supported neural networks.

Similar to the embodiment described with respect to FIG. 1B, in some embodiments the combination of the first neural network 120B and second neural network 122B can together define a third neural network that is usable for image processing. This third network can be trained to minimize error between the input 110B and the output 130B. Output 130B can include a processed portion 144B, along with other processed or unprocessed image portions that together define an output image. The input frames can include multiple frames preceding the most recent frame from the video stream.

FIG. 1C illustrates a recurrent architecture neural network that utilizes multiple neural networks that process selected grids mapped onto an image and includes input only from previously computed state vectors derived from previously processed images. As illustrated, a system or method 100C has one video frame as input 110C into a first neural network 120C. A second neural network 122C can be used to process portion 142C if a need for suitable processing is identified by neural network 120C. Information derived from previous frames is provided to second neural network 122C from neural embeddings, latent vectors, or state vectors 124C and 126C. As illustrated, a system or method 100C has input 110C that includes an input image into a neural network 120C, and output 144C as a portion of image 130C.

FIG. 1D illustrates one embodiment of a neural network supported image or video processing pipeline system and method 100D. This pipeline 100D can use one or more neural networks at multiple points in the image processing pipeline. For example, neural network-based image pre-processing that occurs before image capture (step 110D) can include optional use of neural networks to select one or more of ISO, focus, exposure, resolution, image capture moment (e.g. when eyes are open) or other image or video settings. In addition to using a neural network to simply select reasonable image or video settings, such analog and pre-image capture factors can be automatically adjusted or adjusted to favor factors that will improve efficacy of later neural network processing. For example, flash or other scene lighting can be increased in intensity, duration, or redirected. Filters can be removed from an optical path, apertures opened wider, or shutter speed decreased. Image sensor efficiency or amplification can be adjusted by ISO selection, all with a view toward (for example) improved neural network color adjustments or HDR processing.

After image capture, neural network-based sensor processing (step 112D) can be used to provide custom demosaic, tone maps, dehazing, pixel failure compensation, or dust removal. Other neural network based processing can include Bayer color filter array correction, colorspace conversion, black and white level adjustment, or other sensor related processing. Still other neural network processing can include denoising or other video improvement through use of multiple frame processing, recurrent frame processing, or recurrent neural embedding processing such as respectively described with respect to FIG. 1A, 1B, or 1C.

Optional neural network based global post processing (step 114D) can include resolution or color adjustments, as well as stacked focus or HDR processing. Other global post processing features can include HDR in-filling, bokeh adjustments, super-resolution, vibrancy, saturation, or color enhancements, and tint or IR removal.

Optional neural network based local post processing (step 116D) can include red-eye removal, blemish removal, dark circle removal, blue sky enhancement, green foliage enhancement, or other processing of local portions, sections, objects, or areas of an image. Identification of the specific local area can involve use of other neural network assisted functionality, including for example, a face or eye detector.

Optional neural network-based portfolio post processing (step 116D) can include image or video processing steps related to identification, categorization, or publishing. For example, neural networks can be used to identify a person and provide that information for metadata tagging. Other examples can include use of neural networks for categorization into categories such as pet pictures, landscapes, or portraits.

FIG. 1E illustrates a neural network supported image or video processing system 120E. In one embodiment, hardware level neural control module 122E (including settings and sensors) can be used to support processing, memory access, data transfer, and other low level computing activities. A system level neural control module 124E interacts with hardware module 122E and provides preliminary or required low level automatic picture presentation tools, including determining useful or needed resolution, or lighting or color adjustments. Other neural network processing can include denoising or other video improvement through use of multiple frame processing, recurrent frame processing, or recurrent neural embedding processing such as respectively described with respect to FIG. 1A, 1B, or 1C. Images or video can be processed using a system level neural control module 126E that can include user preference settings, historical user settings, or other neural network processing settings based on third party information or preferences. A system level neural control module 128E can also include third party information and preferences, as well as settings to determine whether local, remote, or distributed neural network processing is needed. In some embodiments, a distributed neural control module 130E can be used for cooperative data exchange. For example, as social network communities change styles of preferred portraits images (e.g. from hard focus styles to soft focus), portrait mode neural network processing can be adjusted as well. This information can be transmitted to any of the various disclosed modules using network latent vectors, provided training sets, or mode related setting recommendations.

In some embodiments, redundant information related to global or local motion in a video can be used to improve video processing throughput and efficiency. For example, denoising and temporally consistent video methods such as described herein are prone to create visual artifacts such as ghosting when applied to moving regions. Techniques are needed to identify motion and prevent application of denoising and temporally consistent video algorithms for those identified moving regions. For example, to identify motion, change in pixel intensities between frames can be measured while compensating for noise and illumination changes. Alternatively or in addition, a CNN can be used predict which pixels have changed as a result of motion by providing frames t and t−1. Only non-moving regions or images are subject to use of the described denoising and temporally consistent video methods.

In other embodiments, various additional algorithms can be used to improve motion models or provide motion compensation. For example, global motion can be estimated using an image represented at multiple scales to perform coarse-to-fine motion estimation. One such multi-scale image representation is the image pyramid (e.g. gaussian, pyramids, laplacian pyramids). In practice, an image is downsampled iteratively until the desired number of resolutions are represented, and grid-search or other motion estimation is performed—first at the lowest resolution and then to progressively higher resolutions, with the output of the previous resolution's matching results feeding into the current matching process to reduce search space.

Improved motion models can also include local motion in some embodiments. An image can be decomposed into the image into regions of consistent motion. An estimate of local motion for each moving region can be done independently using the same or similar techniques as that discussed with respect to global motion.

In some embodiments a CNN can be used to predict not just whether a pixel has experienced motion, but also to classify that motion into one of several ‘motion groups’. Each CNN identified motion group would normally existent consistent motion distinct from global motion and can be compensated for independently.

In some embodiments, computational load can be reduced by taking advantage of motion estimates available in many commonly encoded video formats, including the various HEVC and MPEG related encoders. Motion vectors stored in a compressed video stream can be used to assist in quantifying motion in a video.

FIG. 1F is another embodiment illustrating a neural network supported software system 120F. As shown, information about an environment, including light, scene, and capture medium is detected and potentially changed, for example, by control of external lighting systems or on camera flash systems. An imaging system that includes optical and electronics subsystems can interact with a neural processing system and a software application layer. In some embodiments, remote, local or cooperative neural processing systems can be used to provide information related to settings and neural network processing conditions.

In more detail, the imaging system can include an optical system that is controlled and interacts with an electronics system. The optical system contains optical hardware such as lenses and an illumination emitter, as well electronic, software or hardware controllers of shutter, focus, filtering and aperture. The electronics system includes a sensor and other electronic, software or hardware controllers that provide filtering, set exposure time, provide analog to digital conversion (ADC), provide analog gain, and act as an illumination controller. Data from the imaging system can be sent to the application layer for further processing and distribution and control feedback can be provided to a neural processing system (NPS).

The neural processing system can include a front-end module, a back-end module, user preference settings, portfolio module, and data distribution module. Computation for modules can be remote, local, or through multiple cooperative neural processing systems either local or remote. The neural processing system can send and receive data to the application layer and the imaging system. Multiple neural networks can be used for processing images such as described with respect to FIG. 1A, 1B, or 1C.

In the illustrated embodiment, the front-end includes settings and control for the imaging system, environment compensation, environment synthesis, embeddings, and filtering. The back-end provides linearization, filter correction, black level set, white balance, and demosaic. Both the front-end or back-end neural network processing system can support efficient video processing using multiple neural networks, including denoising, through use of multiple frame processing, recurrent frame processing, or recurrent neural embedding processing such as respectively described with respect to FIG. 1A, 1B, or 1C. User preferences can include exposure settings, tone and color settings, environment synthesis, filtering, and creative transformations. The portfolio module can receive this data an provide categorization, person identification, or geotagging. The distribution module can coordinate sending a receiving data from multiple neural processing systems and send and receive embeddings to the application layer. The application layer provides a user interface to custom settings, as well as image or setting result preview. Images or other data can be stored and transmitted, and information relating to neural processing systems can be aggregated for future use or to simplify classification, activity or object detection, or decision making tasks.

As will be understood, in addition to providing improved and/or denoised images through use of multiple frame processing, recurrent frame processing, or recurrent neural embedding processing, neural networks can be used to modify or control image capture settings in one or more processing steps that include exposure setting determination, RGB or Bayer filter processing, color saturation adjustment, red-eye reduction, or identifying picture categories such as owner selfies, or providing metadata tagging and internet mediated distribution assistance. Neural networks can be used to modify or control image capture settings in one or more processing steps that include denoising with or without temporal consistency features, color saturation adjustment, glare removal, red-eye reduction, and eye color filters. Neural networks can be used to modify or control image capture settings in one or more processing steps that can include but are not limited to capture of multiple images, image selection from the multiple images, high dynamic range (HDR) processing, bright spot removal, and automatic classification and metadata tagging. Neural networks can be used to modify or control image capture settings in one or more processing steps that include video and audio setting selection, electronic frame stabilization, object centering, motion compensation, and video compression.

A wide range of still or video cameras can benefit from use neural network supported image or video processing pipeline system and method. Camera types can include but are not limited to conventional DSLRs with still or video capability, smartphone, tablet cameras, or laptop cameras, dedicated video cameras, webcams, or security cameras. In some embodiments, specialized cameras such as infrared cameras, thermal imagers, millimeter wave imaging systems, x-ray or other radiology imagers can be used. Embodiments can also include cameras with sensors capable of detecting infrared, ultraviolet, or other wavelengths to allow for hyperspectral image processing.

Cameras can be standalone, portable, or fixed systems. Typically, a camera includes processor, memory, image sensor, communication interfaces, camera optical and actuator system, and memory storage. The processor controls the overall operations of the camera, such as operating camera optical and sensor system, and available communication interfaces. The camera optical and sensor system controls the operations of the camera, such as exposure control for image captured at image sensor. Camera optical and sensor system may include a fixed lens system or an adjustable lens system (e.g., zoom and automatic focusing capabilities). Cameras can support memory storage systems such as removable memory cards, wired USB, or wireless data transfer systems.

In some embodiments, neural network processing can occur after transfer of image data to a remote computational resources, including a dedicated neural network processing system, laptop, PC, server, or cloud. In other embodiments, neural network processing can occur within the camera, using optimized software, neural processing chips, dedicated ASICs, custom integrated circuits, or programmable FPGA systems.

In some embodiments, results of neural network processing can be used as an input to other machine learning or neural network systems, including those developed for object recognition, pattern recognition, face identification, image stabilization, robot or vehicle odometry and positioning, or tracking or targeting applications. Advantageously, such neural network processed image normalization can, for example, reduce computer vision algorithm failure in high noise environments, enabling these algorithms to work in environments where they would typically fail due to noise related reduction in feature confidence. Typically, this can include but is not limited to low light environments, foggy, dusty, or hazy environments, or environments subject to light flashing or light glare. In effect, image sensor noise is removed by neural network processing so that later learning algorithms have a reduced performance degradation.

In some embodiments, neural networks can be used in conjunction with neural network embeddings that reduce the dimensionality of categorical variables and represent categories in the transformed space can be used. Neural embeddings are particularly useful for categorization, tracking, and matching, as well as allowing a simplified transfer of domain specific knowledge to new related domains without needing a complete retraining of a neural network. In some embodiments, neural embeddings can be provided for later use, for example by preserving a latent vector in image or video metadata to allow for optional later processing or improved response to image related queries. For example, a first portion of an image processing system can be arranged to reduce data dimensionality, effectively downsample an image, images, or other data, or provide denoising through efficient video processing using multiple neural networks support utilization of neural embedding information. A second portion of the image processing system can also be arranged for at least one of categorization, tracking, and matching using neural embedding information derived from the neural processing system. Similarly, neural network training system can include a first portion of a neural network algorithm arranged to reduce data dimensionality and effectively downsample an image or other data using a neural processing system to provide neural embedding information. A second portion of a neural network algorithm is arranged for at least one of categorization, tracking, and matching using neural embedding information derived from a neural processing system and a training procedure is used to optimize the first and second portions of the neural network algorithm.

In some embodiments, a training and inference system can include a classifier or other deep learning algorithm that can be combined with the neural embedding algorithm to create a new deep learning algorithm. The neural embedding algorithm can be configured such that its weights are trainable or non-trainable, but in either case will be fully differentiable such that the new algorithm is end-to-end trainable, permitting the new deep learning algorithm to be optimized directly from the objective function to the raw data input. During inference, the above-described algorithm can be partitioned such that the embedding algorithm that executes on an edge or endpoint device, while other algorithms can execute on a centralized computing resource (cloud, server, gateway device).

In certain embodiments, multiple image sensors can collectively work in combination with the described neural network processing to enable wider operational and detection envelopes, with, for example, sensors having different light sensitivity working together to provide high dynamic range images. In other embodiments, a chain of optical or algorithmic imaging systems with separate neural network processing nodes can be coupled together. In still other embodiments, training of neural network systems can be decoupled from the imaging system as a whole, operating as embedded components associated with particular imagers.

In some embodiments, the described system can take advantage of bus mediated communication of neural network derived information, including a latent vector. For example, a multi-sensor processing system can operate to send information derived from one or more images and processed using neural processing path for encoding. This latent vector, along with optional other image data or metadata can sent over a communication bus or other suitable interconnect to a centralized processing module. In effect, this allows individual imaging systems to make use of neural embeddings to reduce bandwidth requirements of the communication bus, and subsequent processing requirements in the central processing module.

Bus mediation communication of neural networks can greatly reduce data transfer requirements and costs. For example, a city, venue, or sports arena IP-camera system can be configured so that each camera outputs latent vectors for a video feed. These latent vectors can supplement or entirely replace images sent to a central processing unit (e.g. gateway, local server, VMS, etc.). The received latent vectors can be used to performs image filtering, video denoising or other image processing techniques using efficient video processing with multiple neural networks. In some embodiments, the neural networks can support image analytics, or provide processed images combined with original video data to be presented to human operators. This allows performance of realtime analysis on hundreds or thousands of cameras, without needing access to large data pipeline and a large and expensive server.

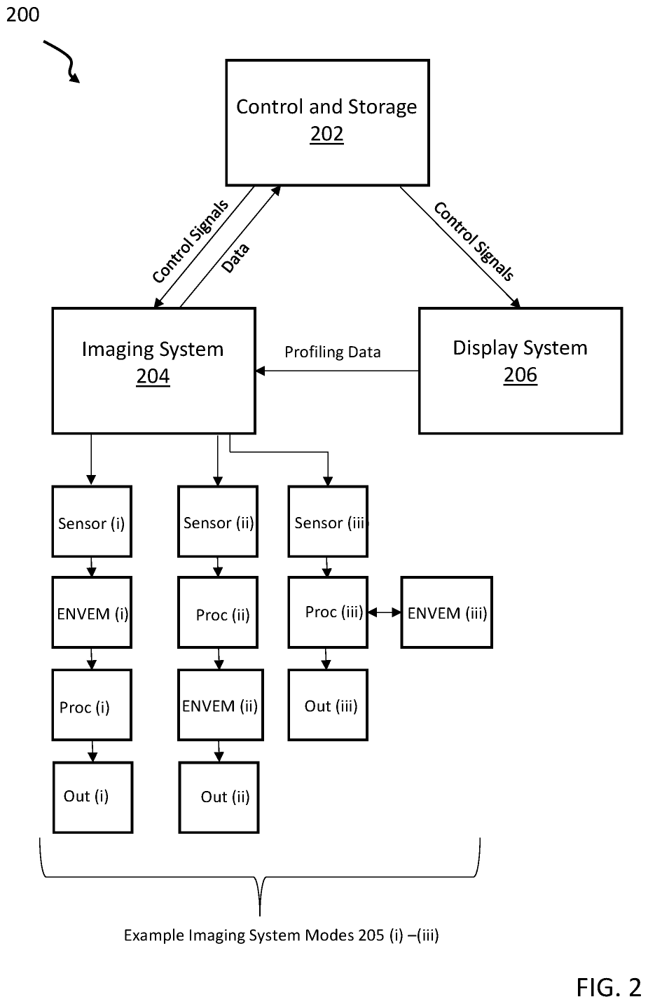

FIG. 2 generally describes hardware support for use and training of neural networks and image processing algorithms. In some embodiments, neural networks can be suitable for general analog and digital image processing. A control and storage module 202 able to send respective control signals to an imaging system 204 and a display system 206 is provided. The imaging system 204 can supply processed image data to the control and storage module 202, while also receiving profiling data from the display system 206. Training neural networks in a supervised or semi-supervised way requires high quality training data. To obtain such data, the system 200 provides automated imaging system profiling. The control and storage module 202 contains calibration and raw profiling data to be transmitted to the display system 206. Calibration data may contain, but is not limited to, targets for assessing resolution, focus, or dynamic range. Raw profiling data may contain, but is not limited to, natural and manmade scenes captured from a high quality imaging system (a reference system), and procedurally generated scenes (mathematically derived).

An example of a display system 206 is a high-quality electronic display. The display can have its brightness adjusted or may be augmented with physical filtering elements such as neutral density filters. An alternative display system might comprise high quality reference prints or filtering elements, either to be used with front or back lit light sources. In any case, the purpose of the display system is to produce a variety of images, or sequence of images, to be transmitted to the imaging system.

The imaging system 204 being profiled is integrated into the profiling system such that it can be programmatically controlled by the control and storage computer and can image the output of the display system. Camera parameters, such as aperture, exposure time, and analog gain, are varied and multiple exposures of a single displayed image are taken. The resulting exposures are transmitted to the control and storage computer and retained for training purposes. In some embodiments, the entire system is placed in a controlled lighting environment, such that the photon “noise floor” is known during profiling.

The imaging system 204 can also include various types of neural networks can be referred to as efficient neural video enhancement modules (ENVEM) that can be configured in accordance with systems such as disclosed with respect to FIGS A-F. As shown in FIG. 2, processing mode or order can be selected, with some embodiments conducting ENVEM neural network processing immediately after sensor image capture, other embodiments conducting ENVEM neural network processing after conventional image processing, or still other embodiments conducting ENVEM neural network processing in parallel or contemporaneous with respect to conventional image processing.

The entire system is setup such that the limiting resolution factor is the imaging system. This is achieved with mathematical models which take into account parameters, including but not limited to: imaging system sensor pixel pitch, display system pixel dimensions, imaging system focal length, imaging system working f-number, number of sensor pixels (horizontal and vertical), number of display system pixels (vertical and horizontal). In effect a particular sensor, sensor make or type, or class of sensors can be profiled to produce high-quality training data precisely tailored to an individual sensors or sensor models.

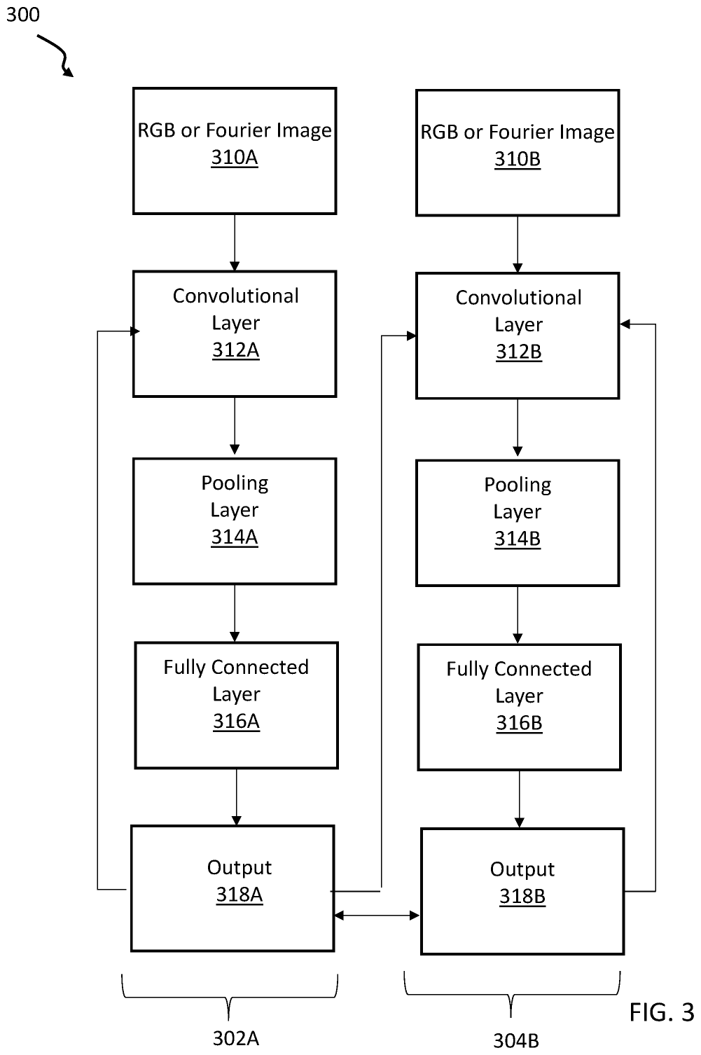

Various types of neural networks can be used with the systems disclosed with respect to FIGS A-F and FIG. 2, including fully convolutional, recurrent, generative adversarial, or deep convolutional networks. Convolutional neural networks are particularly useful for image processing applications such as described herein. As seen with respect to FIG. 3, a system 300 can include multiple interacting and recurrent convolutional neural networks 302A and 302B. Neural network-based sensor processing can receive a single underexposed RGB or Fourier image 310A or B as input. RAW formats are preferred, but compressed JPG images can be used with some loss of quality. Images can be pre-processed with conventional pixel operations or can preferably be fed with minimal modifications into a trained convolutional neural network 302A or B. Processing can proceed through one or more convolutional layers 312A or B, pooling layer 314A or B, a fully connected layer 316A or B, and end with output 318A or B of the improved image. In operation, one or more convolutional layers apply a convolution operation to the RGB input, passing the result to the next layer(s). After convolution, local or global pooling layers can combine outputs into a single or small number of nodes in the next layer. Repeated convolutions, or convolution/pooling pairs are possible. After neural base sensor processing is complete, the output can be passed between neural networks 302A or B, to another local neural network (not shown), or in addition or alternatively to neural network based global post-processing for additional neural network-based modifications.

One neural network embodiment of particular utility is a fully convolutional and recurrent neural network. A fully convolutional and recurrent neural network is composed of convolutional layers without any fully connected layers usually found at the end of the network. Advantageously, fully convolutional neural networks are image size independent, with any size images being acceptable as input for training or bright spot image modification. Recurrent behavior is provided by feeding at least some portion of output back into the convolutional layer or to other connected neural networks.

In some embodiments, neural network embeddings are useful because they can reduce the dimensionality of categorical variables and represent categories in the transformed space. Neural embeddings are particularly useful for categorization, tracking, and matching, as well as allowing a simplified transfer of domain specific knowledge to new related domains without needing a complete retraining of a neural network. In some embodiments, neural embeddings can be provided for later use, for example by preserving a latent vector in image or video metadata to allow for optional later processing or improved response to image related queries. For example, a first portion of an image processing system can be arranged to reduce data dimensionality and effectively downsample an image, images, or other data using a neural processing system to provide neural embedding information. A second portion of the image processing system can also be arranged for at least one of categorization, tracking, and matching using neural embedding information derived from the neural processing system. Similarly, neural network training system can include a first portion of a neural network algorithm arranged to reduce data dimensionality and effectively downsample an image or other data using a neural processing system to provide neural embedding information. A second portion of a neural network algorithm is arranged for at least one of categorization, tracking, and matching using neural embedding information derived from a neural processing system and a training procedure is used to optimize the first and second portions of the neural network algorithm.

As will be understood, the camera system and methods described herein can operate locally or in via connections to either a wired or wireless connect subsystem for interaction with devices such as servers, desktop computers, laptops, tablets, or smart phones. Data and control signals can be received, generated, or transported between varieties of external data sources, including wireless networks, personal area networks, cellular networks, the Internet, or cloud mediated data sources. In addition, sources of local data (e.g. a hard drive, solid state drive, flash memory, or any other suitable memory, including dynamic memory, such as SRAM or DRAM) that can allow for local data storage of user-specified preferences or protocols. In one particular embodiment, multiple communication systems can be provided. For example, a direct Wi-Fi connection (802.11b/g/n) can be used as well as a separate 4G cellular connection.

Connection to remote server embodiments may also be implemented in cloud computing environments. Cloud computing may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

The flow diagrams and block diagrams in the described Figures are intended to illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. An image processing pipeline, comprising:
an image processing system having multiple neural networks arranged to receive multiple input images, with the images having identifiable objects and noise features; and wherein
a first neural network provides image information to a second neural network that recurrently processes the image information to both improve output presentation of identifiable objects and reduce noise features.

2. An image processing pipeline, comprising:
an image processing system having multiple neural networks arranged to receive multiple input images, with the images having identifiable objects and noise features; and wherein
a first neural network provides image information to a second neural network that recurrently processes the image information to both improve output presentation of identifiable objects and reduce noise features, with processing including use of state vector information created by neural network processing of earlier images.

3. A video camera image processing system, comprising:
a motion identification and estimation system that identifies at least one of global and local moving regions;
an image processing system having multiple neural networks arranged to receive multiple input images, with the images having identifiable objects and noise features; and wherein using the motion identification and estimation system, the neural network processes non-moving portions of at least one input image using a first neural network that provides image information based on a selected portion of an image to a second neural network that recurrently processes the image information to both improve output presentation of identifiable objects and reduce noise features, with processing including use of state vector information created by neural network processing of earlier images.

4. A video camera image processing system, comprising:
an image processing system having multiple neural networks arranged to receive multiple input images, with the images having identifiable objects and noise features; and wherein
a first neural network provides image information based on a selected portion of an image to a second neural network, with the second neural network working with the first neural network as a combined neural network to recurrently process the image information to reduce noise features, with processing including use of state vector information created by neural network processing by the combined neural network of earlier images.

5. A video camera image processing system, comprising:
an image processing system having multiple neural networks arranged to receive multiple input images, with the images having identifiable objects and noise features; and wherein
a first neural network provides image information based on a selected portion of an image to a second neural network that recurrently processes the image information to both improve output presentation of identifiable objects and reduce noise features, with processing including use of state vector information created by neural network processing of earlier images; and
a neural network arranged to modify at least one of an image capture setting, sensor processing, global post processing, local post processing, portfolio post processing, or provide latent vectors and neural embedding information to the first or second neural networks.

6. The image processing pipeline of claim 4, wherein the neural embedding information includes a latent vector.

7. The image processing pipeline of claim 4, wherein the neural embedding information includes at least one latent vector that is sent between modules in the image processing system.

8. The image processing pipeline of claim 4, wherein the neural embedding includes at least one latent vector that is sent between one or more neural networks in the image processing system.
